(19) United States
(12) Patent Application Publication
(10) Pub. No.: US 2024/0346435 A1
(43) Pub. Date: Oct. 17, 2024

(54) AUTONOMOUS ARTIFICIAL INTELLIGENCE SYSTEM FOR REDUCING THE SPOILAGE OF FOOD

(71) Applicant: Techolution Consulting LLC, New York, NY (US)

(72) Inventor: Luv Tulsidas, New York, NY (US)

(73) Assignee: Techolution Consulting LLC, New York, NY (US)

(21) Appl. No.: 18/298,593

(22) Filed: Apr. 11, 2023

(51) Int. Cl. G06Q 10/087; G06Q 30/0202; G06V 10/764; G06V 20/68

(52) U.S. Cl. CPC G06Q 10/087; G06Q 30/0202; G06V 10/764; G06V 20/68; G06V 2201/07

(57) ABSTRACT

The present application provides an interactive and predictive autonomous AI system leveraging IoT, AI and computer vision, and allowing a cloud based systems to actively monitor a classified inventory of food items, advising the restaurants/food outlets staff the amount of food products to be prepared and stocked based on a Forecasting AI module, thereby maximizing efficiency with respect to food usage and minimizing food spoilage. The system autonomously captures images of inventory, both incoming and outgoing, classifies (shape/color) the images of the inventory, further trains and corrects the AI model in real time and concurrently with the image capture process, to ensure accuracy via a co-pilot module, which ultimately accurately predicts the exact amount of food products in inventory to be sold within a prescribed time frame, based on several parameters (such as historical usage data, weather data, etc.) using the forecast AI module.

### TECHNICAL FIELD OF THE INVENTION

The present application relates to is an AI powered autonomous system for actively classifying and monitoring a classified inventory of food items, advising restaurants/food outlets' staff regarding the amount of food product in inventory, the amount of food to be prepared for the near term, and product needing to be restocked based on the Forecasting AI module.

### BACKGROUND OF THE INVENTION

Food wastage has been a topic of great concern for many years. It has been described as a major concern in the long-term sustainability of food production, demand, and food supply chains.

Internet of Things (IoT) links anything, everywhere, and at any time and by incorporating the IoT into the Food Supply Chain (FSC) management, it is possible to improve food usage efficiency. Currently, the usage of IT technologies to solve problems in the food industry in still in the early stages.

In fact, food waste is a systemic problem that happens along every step of the food supply chain, from farm and field to fork. In the United States alone, restaurants generate an estimated 20-30 billion pounds of food waste annually. The potential drivers of food waste at restaurants can include improper food storage, extensive menu choices, and unsuccessful employee training. These factors are only exacerbated by unpredictable supply and demand, and inflexible supply chains to support this fluctuation.

Once food waste ends up in a landfill, it contributes to harming the climate by releasing harmful emissions such as methane, a greenhouse gas that's estimated to be more powerful than carbon dioxide.

Currently, businesses looking to mitigate food waste have resorted to manually tracking and recording the quantity, frequency, and types of food being thrown away. But without more granular visibility into their waste streams, tackling the problem remains a significant challenge.

The existing food wastage solutions have several disadvantages. A huge amount of food is wasted or spoiled due to non-availability of the necessary automated solutions for determining the exact amount of food to be prepared within a defined amount of time and involves a high amount of raw material, labor, energy and logistics.

In most of the existing systems, food items are manually counted, and employee's make a guess on the amount of food to be stocked, leading to obscene amounts of food being wasted. Moreover, employees are unable to identify what amount of food products need to be sold in a time frame i.e., how much to prepare and not to prepare cannot be determined, with any precision and often overcompensate.

The existing AI systems use a large number of iterations to train a model and are slow and consume a lot of time to train the data sets. The interaction between the employees and customers is manual rather than automatic. The employees manually interact with the system and don't have any information/status with respect to the data (i.e., non-data driven) to be analyzed.

Furthermore, the current systems are ineffective and are not adaptable during external conditions, lack non-spontaneous reactions and are unable to catch new inputs or data.

Several attempts have been made to develop drive through systems, however these systems fail to provide an efficient real time feedback of inventory.

Due to the aforementioned drawbacks, there is a need to develop a novel autonomous AI system (highly adaptable and scalable) for reducing reduce food spoilage by more than half and providing Environmental, Social and Governance (ESG) benefits involving massive reduction in carbon dioxide emissions and save material cost and huge amounts of money.

### SUMMARY OF THE INVENTION

The present invention is directed towards an autonomous artificial intelligence system that uses a mechanism of real time processing and feedback of inventory (food products) and predicting the exact amount of food product to be prepared and stocked based on the Forecasting AI module.

In an embodiment of the present invention, the system comprises of an Edge device including connected to camera for gathering images of the food items continuously in real time and processing images and transferring it to a cloud server; a cloud server that detects the items inside the image(s), classifies inventory count is calculated and displayed on a dashboard; a copilot real time that assists the machine learning model to identify and correct the errors (data is sent back to real time feedback loop for daily AI training cycle) and a Forecasting AI module, wherein this module calculates the no. of food products sold in a particular time frame and thereafter predicts in real time the number of food products to be sold for future time frames.

The system consists of an Edge device connected to a camera for gathering images of the food items in real time, processing and transferring the images to a cloud server. The server autonomously detects the items inside the image, classifies (shape/color) the inventory counts and displays (presents) inventory counts on the dashboard. There preferably is a co-pilot module that assists the machine learning model to identify and correct the errors and a Forecasting AI module that calculates the number of food products sold in a particular time frame and advises the staff amount of food products to be prepared and stocked during a particular time period to reduce food wastage and its associated carbon footprint.

While the invention has been described and shown with particular reference to the preferred embodiment, it will be apparent that variations might be possible that would fall within the scope of the present invention.

### BRIEF DESCRIPTION OF THE DRAWINGS

The foregoing summary, as well as the following detailed description of various embodiments, is better understood when read in conjunction with the drawings provided herein. For the purposes of illustration, the drawings disclose subject matter which is not limited to the specific methods and instrumentalities disclosed. Further, the advantages and features of the present disclosure will better understand with reference to the following detailed description and claims taken in conjunction with the accompanying drawing, wherein like elements are identified with like symbols, and in which:

FIG. 1 illustrates a block diagram representing the major elements of the autonomous artificial intelligence system; and

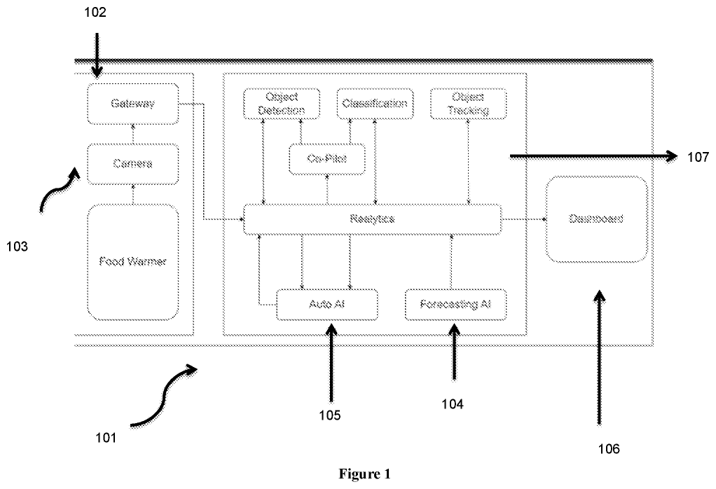

FIG. 2 illustrates a flow diagram according to an exemplary embodiment of the present invention.

### DETAILED DESCRIPTION OF THE INVENTION

The following description describes at least a preferred embodiment of the present invention. It will be clear from this description of the invention that the invention is not limited to these illustrated embodiments but that the invention also includes a variety of modifications and embodiments thereto. Therefore, the present description should be seen as illustrative and not limiting. While the invention is susceptible to various modifications and alternative constructions, it should be understood, that there is no intention to limit the invention to the specific form disclosed, but, on the contrary, the invention is to cover all modifications, alternative constructions, and equivalents falling within the spirit and scope of the invention as defined in the claims.

In any embodiment described herein, the open-ended terms “comprising,” “comprises,” and the like (which are synonymous with “including,” “having” and “characterized by”) may be replaced by the respective partially closed phrases “consisting essentially of,” consists essentially of,” and the like or the respective closed phrases “consisting of,” “consists of, the like.

As used herein, the singular forms “a,” “an,” and “the” designate both the singular and the plural, unless expressly stated to designate the singular only.

Further, the use of terms “first”, “second”, and “third”, and the like, herein do not denote any order, quantity, or importance, but rather are used to distinguish one element from another.

The present application provides a novel autonomous AI system that ultimately food spoilage/waste by allowing a cloud based server to actively classify and monitor a classified inventory of food items and advise restaurants/food outlets staff the amount of food products to be prepared for a relevant amount of time and stocked/restocked based on the Forecasting AI module.

The proposed system is resolving the challenges faced by restaurants/food outlets (grab and go food warmers) employees who are unable to identify what food product and how much food product is to be prepared and stocked (not proactive), resulting in food waste.

The primary advantage of this highly adaptable and scalable system is to reduce food waste by more than half and further contribute to Environmental, Social and Governance (ESG) benefits involving massive reduction in carbon dioxide emissions and save material cost and huge amounts of money.

The system autonomously captures images, detects food in the images (both incoming and outgoing), classifies (shape/color) the inventory counts, further trains and corrects the AI model in real time to ensure accuracy and reducing errors, via the co-pilot module integrated with Auto AI model and accurately predicts the exact amount of food products to be prepared within a prescribed time frame based on several parameters (such as historical usage data, weather data, etc.) using the forecast AI module. The Forecast AI module functions by sending a message to the restaurant staff advising them how much food products are to be prepared and stocked during a particular time period, as explained in greater detail below.

Referring to Figure that illustrates a block diagram representing the major elements of the autonomous artificial intelligence system 101 that includes of an edge device 102; an array of external input peripherals, including but not limited to sensors and/or camera devices 103 for gathering real time data of the inventory and/or inventory usage, and processing them by the local edge device 102 processor; a cloud server for receiving the processed data of the inventory from the edge device 102, wherein the cloud server uses a computer vision model to detect the inventory from the data, classifies the inventory, and calculates and displays inventory counts on a dashboard 106, along with forecasts 104 with respect to inventory usage.

Furthermore, the system may include a proprietary AI model 105 that autonomously detects food products in the gathered data, classifies (shape/color) and counts the inventory (preferably, incoming, existing, and outgoing, further trains and corrects the model based on the inventory counts in real time for each AI model. A co-pilot module 107 may assist in identifying and fixing the errors in AI model 105 predictions and further reflecting the corrections in the system in real time. A Forecasting AI module 104, wherein the module accurately predicts the amount of inventory to be prepared/sold within a prescribed time frame based on several parameters (such as historical usage data, weather data, etc.). The Forecast AI module 104 displays the forecasted data on the dashboard, advising the user on the quantity of inventory to be prepared for the given time and restocked.

The inventory is preferably computed via an ensemble of three AI models namely object detection, classification, and object tracking models. For example, the object detection model may be trained with respect to incoming products, from images of prepared and/or unprepared food as the food is being delivered to the food establishment, including food in packaging. That is, the model may be trained to detect a box or other packaging containing eggs, meat, milk, sugar, flour, cans, etc., as well as unpackaged items. The object detection module may also be trained with respect to outgoing products, including plated items sent to customers and items disposed of. Once items of interest in the images are detected, the information is passed to the classification module that classifies the items in the image. For example, an incoming box may be classified as a box containing a gross of eggs. Similarly, a bag may be classified as a 50 lb. bag of flour. Outgoing items may include a plated half chicken with two sides, or uneaten portions thereof returned from the customer for disposal. Finally, the object tracker module tracks the classified items and updates the records accordingly to reflect accurate usage of the food.

The system may also include a real time feedback loop for in-depth assessment and daily AI training cycle for model evolution that is adaptable to changes and/or unseen data along with continuous AI model evolution and/or improved performance and adaptability to new inputs.

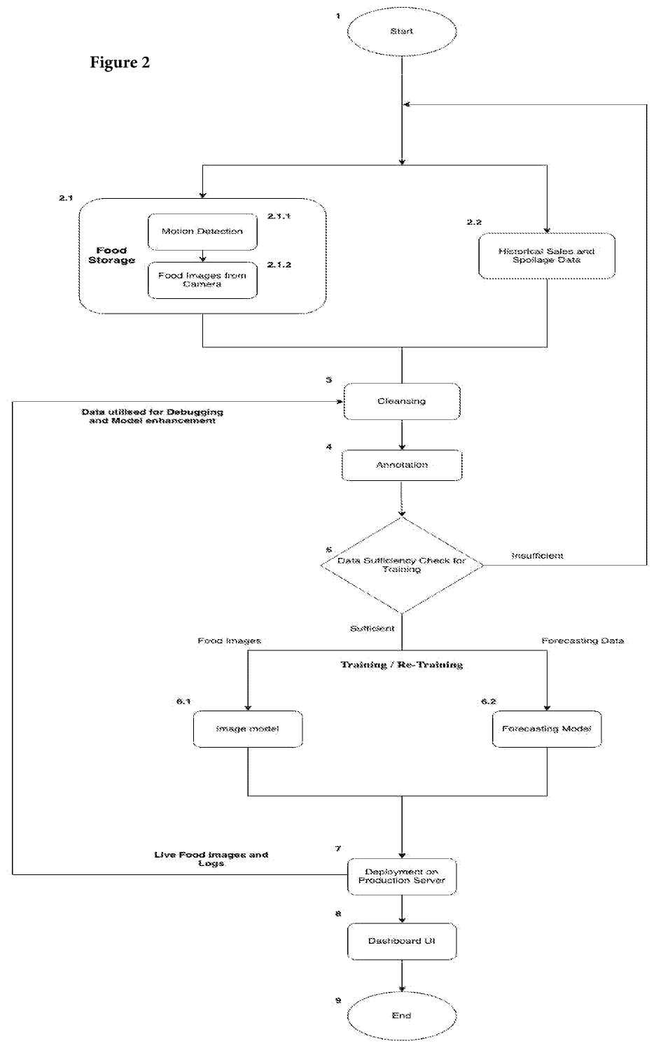

Referring to FIG. 2 that illustrates a flow diagram according to an exemplary embodiment of the present invention. The process flow comprises of the below steps:
Step 1: Start of Flow. In a preferred embodiment, the system will include a plurality of cameras at all locations where food is moved in a given establishment. For example, a camera may be located at the delivery door, walk in box/freezer, and warming station(s). The cameras preferably capture and update the system in real time with respect to the functions discussed herein. The images captured include packaged and/or uncooked food, which are added to the inventory as the food is delivered to the establishment, and prepared food usage.
Step 2.1: Motion Detection and Image Capturing via an HD Camera attached with an IoT Device for Training Models based on Images. This step can be further segregated into the following steps. Step 2.1.1: Motion Detection occurs when food items are incoming and/or outgoing, for example, when items get picked up by the waiters for sales or when discarded as spoilage and Step 2.1.2: Capturing of Image and post processing when motion ceases in front of the camera.
Step 2.2: Aggregating and Processing Historical Sales and Spoilage Data, along with necessary feature generation crucial for Training Forecasting Model. In this step, the system may be trained based on historical sales to predict usage in the near future. Various data points may be used, including seasonal data, time of day, weather patterns, etc. For example, certain dishes may be more popular during a warm summer evening, as compared to a snowy winter brunch. For instance, the demand for ice cream will be greater in the summer vs. the winter.
Step 3: Cleansing of Collected Dataset for Quality Assurance is done to make sure only pristine data gets through the training process of Image Models. This can be done manually or semi-manually.
Step 4: Annotation of Cleansed Dataset for Model Training is done for various model types like object detection, instance segmentation and classification. This too may be done manually or semi-manually.
Step 5: Data Sufficiency Check for Training or Collecting more Data is done to assure first iteration of training is best effort done.
Step 6.1: Training Image based Models like Object Detection Model, Instance Segmentation Model and Image Classification Model is done.
Step 6.2: Training Time Series Forecasting Models based on finalised historical sales and spoilage data to forecast how many items to make periodically, for example every 15 minutes for the next 15 minutes.
Step 7: Deployment of Models to Production Server on Kubernetes having robust monitoring and data-drift check integrated via Auto AI. That is, the models are deployed via a remote server, which obtains the images captured at the food establishment in real time, classifies the products in the images, and updates inventories/predictions periodically. For example, the system may determine that a gross of eggs have been deliver, which is added to the inventory, whereas the system may recognize that a dish served consumes three eggs, for example, and the number of eggs used per dish is removed from the inventory in real time.
Step 8: Dashboard UI for Analyzed Results, is displayed at the local device for use. The information may include a listing of current inventory, inventory needing to be replenished, as well as predictions for the food products needing to be prepared in the short term, for example, the next day, next hour, etc.
Step 9: End of Flow

The Automatic Feedback loop system captures, processes and transfers camera and/or sensor data/audio data along with the AI model output decision to the cloud and downloading firmware which facilitates transfer of data (software or AI model update) from the cloud to the edge device 102.

There preferably is a System on Module (SOM) embedded with a processor and interfaced with wireless network protocols and/or cellular network technology; the wireless network protocol and/or cellular network technology connected to the server, wherein the protocol enables uploading of data by transferring field ground data from the system to the server and downloading firmware which facilitates transfer of data (software or AI model update) from the cloud to the edge device which establishes an automatic feedback loop system.

The cloud platform here may be referred to as a cloud or a physical server located in a remote location. The cloud platform comprises a plurality of computing devices that are distributed over a plurality of geographical areas. The cloud platform is configured to function as a server and database that stores user information, etc.

Although the present disclosure has been described in terms of certain preferred embodiments and illustrations thereof, other embodiments and modifications to preferred embodiments may be possible that are within the principles and spirit of the invention. The above descriptions and figures are therefore to be regarded as illustrative and not restrictive.

Thus, the scope of the present disclosure is defined by the appended claims and includes both combinations and sub combinations of the various features described herein above as well as variations and modifications thereof, which would occur to persons skilled in the art upon reading the foregoing description.

1. An autonomous AI system 101 for reducing food wastage, comprising;
an edge device;
an array of external input peripherals comprising at least one of sensors and camera devices connected to the edge device for gathering real time data of the inventory and processing the data of the inventory by the processor;
a cloud server connected to the edge device for receiving the processed data of the inventory, wherein the cloud server using computer vision model detects the inventory from the data, classifies the inventory, calculates inventory based on the classification, and displays inventory on a dashboard, along with forecasting inventory demand for a future period of time;
wherein said system further comprises:
a proprietary AI model that autonomously detects, classifies (shape/color) and computes the inventory count of various products on the shelf, further trains and corrects the inventory count in real time for each AI model;
a co-pilot module that assists in identifying and fixing the errors in AI model predictions and further reflecting the corrections in the system in real time; and
a Forecasting AI module, wherein the module accurately predicts the exact amount of inventory to be sold within a prescribed time frame based on several parameters (historical data, weather data etc.); and
wherein said module 104 displays the forecasted data on the dashboard, advising the user on the quantity of inventory to be prepared and stocked.

2. The system according to claim 1, wherein the server actively monitors a classified inventory, advises the restaurants/food outlets staff how much food products are to be prepared based on the Forecasting AI module 104.

3. The system according to claim 1, wherein the highly scalable system has the potential to maximize sales and minimize food spoilage.

4. The system according to claim 1, wherein the inventory includes food items but not limited to breakfast and lunch items.

5. The system according to claim 1, wherein the inventory is computed via an ensemble of multiple AI models not limited to object detection, classification and object tracking.

6. The system according to claim 1, wherein said system includes a feedback loop that involves correction of the AI model's 105 decisions in real time or post the completion of the classified inventory count through a no-code solution, thereby expediting the timeline of the AI model's 105 learning process and improving its performance.
